(19) United States
(12) Patent Application Publication
(10) Pub. No.: US 2015/0060165 A1
(43) Pub. Date: Mar. 5, 2015

(54) HYBRID CONSTRUCTION MACHINE

(71) Applicants: Jai-Wook Shin, Gimhae-shi (KR); Hoon Kim, Changwon-shi (KR)

(72) Inventors: Jai-Wook Shin, Gimhae-shi (KR); Hoon Kim, Changwon-shi (KR)

(73) Assignee: VOLVO CONSTRUCTION EQUIPMENT AB, Eskilstuna (SE)

(21) Appl. No.: 14/389,789

(22) PCT Filed: Apr. 13, 2012
(86) PCT No.: PCT/KR2012/002806

§ 371 Date: Oct. 1, 2014

(51) Int. Cl. E02F 9/08; B60K 6/46; E02F 9/20

(52) U.S. Cl. CPC E02F 9/0858; E02F 9/20; B60K 6/46
USPC 180/65.245

(57) ABSTRACT

Disclosed is a hybrid construction machine in which a power component, including a generator interposed between an engine and a hydraulic pump, has multiple mounting points so as to be stably supported. The hybrid construction machine according to the present invention comprises an engine and a generator mounted in an upper frame, a power component, including the generator, connected between the engine and a hydraulic pump, and a plurality of fixing plates fixed on the upper frame, each of which has a mounting hole for fixing the power component.

### FIELD OF THE INVENTION

The present invention relates to a hybrid construction machine. More particularly, the present invention relates to a hybrid construction machine in which a power component including a generator interposed between an engine and a hydraulic pump has a plurality of mounting points so that the power component can be stably supported.

### BACKGROUND OF THE INVENTION

As shown in FIG. 1, a construction machine using an engine as a power source in accordance with the prior art includes a hydraulic pump 1 that supplies a hydraulic fluid to a hydraulic actuator or the like, and an engine 2 connected to the hydraulic pump 1 so as to drive the hydraulic pump 1.

A power component 3 consists of the hydraulic pump 1 and the engine 2. The power component 3 is mounted on an upper fame 4 in a four-point supporting manner due to its short axis length.

The power component 3 is mounted on several brackets 5 (e.g., four brackets) that are separately weldingly fixed to the upper frame 4. For this reason, the respective brackets 5 fixed to the upper frame are flush with each other horizontally so that the power component 3 mounted on the brackets 5 is maintained in a horizontal state. However, such a conventional construction machine entails a problem in that it is difficult to weldingly fix the brackets to the upper frame 4 in a state in which the brackets are flush with each other horizontally, thereby degrading workability.

### DETAILED DESCRIPTION OF THE INVENTION

### Technical Problems

Accordingly, the present invention has been made to solve the aforementioned problem occurring in the prior art, and it is an object of the present invention to provide a hybrid construction machine in which a power component including a generator interposed between an engine and a hydraulic pump has a plurality of mounting points so that the power component can be stably supported.

Another object of the present invention is to provide a hybrid construction machine in which a power component including an engine, a generator, and a hydraulic pump can be mounted on fixing plates securely fixed to a top plate of an upper frame.

### Technical Solution

To accomplish the above object, in accordance with an embodiment of the present invention, there is provided a hybrid construction machine having an engine and a generator that are mounted on an upper frame, including:

a power component including the generator connected between the engine and a hydraulic pump; and

a plurality of fixing plates securely fixed to the upper frame, each fixing plate having one or more mounting holes formed thereon to allow the power component to be securely fixed thereto.

In accordance with a preferred embodiment, the fixing plates may be securely fixed to a top plate of the upper frame.

Each of the fixing plates may have at least three mounting holes formed thereon so that the power component can be mounted on the fixing plates in at least six-point supporting manner.

Each of the fixing plates may be formed to have a length projecting to the outside of the top plate, and may have a cross section formed in a “ [symbol] ” shape.

### Advantageous Effect

The hybrid construction machine in accordance with an embodiment of the present invention as constructed above has the following advantages.

The power component including the generator interposed between the engine and the hydraulic pump has a plurality of mounting points (e.g., the power component is mounted on the fixing plates in a six-point-supporting manner) so that the power component can be stably supported. In addition, the power component is simply mounted on the fixing plates securely fixed to the top plate of the upper frame, thereby improving workability.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a perspective view showing a state in which a power component is mounted in a construction machine using an engine as a power source in accordance with the prior art;

FIG. 2 is a perspective view showing a state in which a power component is mounted in a hybrid construction machine in accordance with an embodiment of the present invention; and

FIG. 3 is a perspective view showing an upper frame on which an engine and the like are to be mounted in a hybrid construction machine in accordance with an embodiment of the present invention;

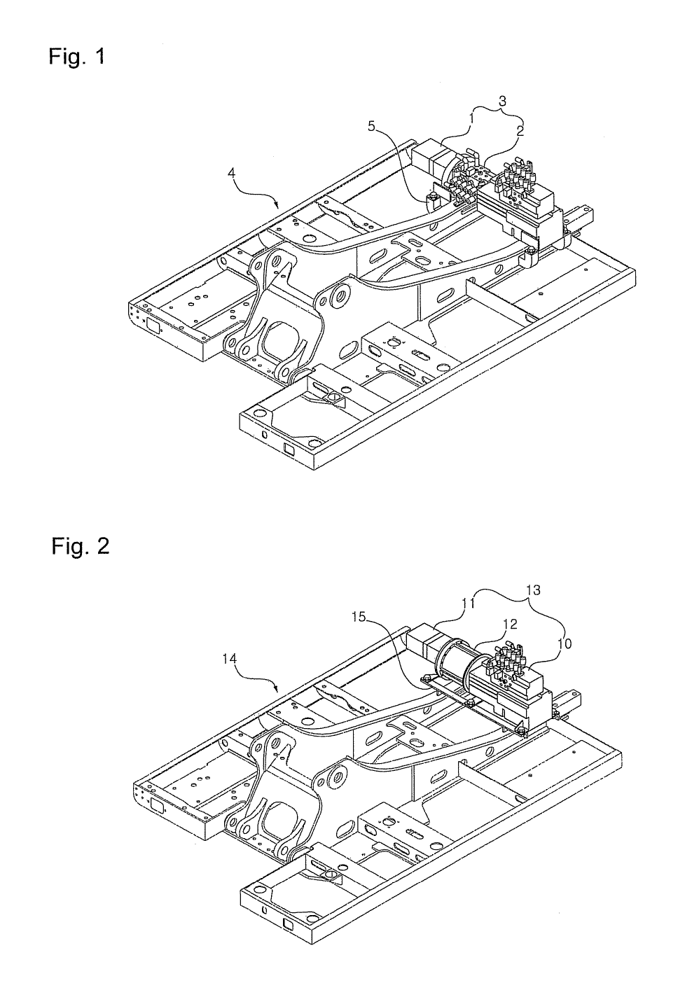

### EXPLANATION ON REFERENCE NUMERALS OF MAIN ELEMENTS IN THE DRAWINGS

10: engine
11: hydraulic pump
12: generator
13: power component
14: upper frame
15: fixing plate
16: top plate
17: mounting hole

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

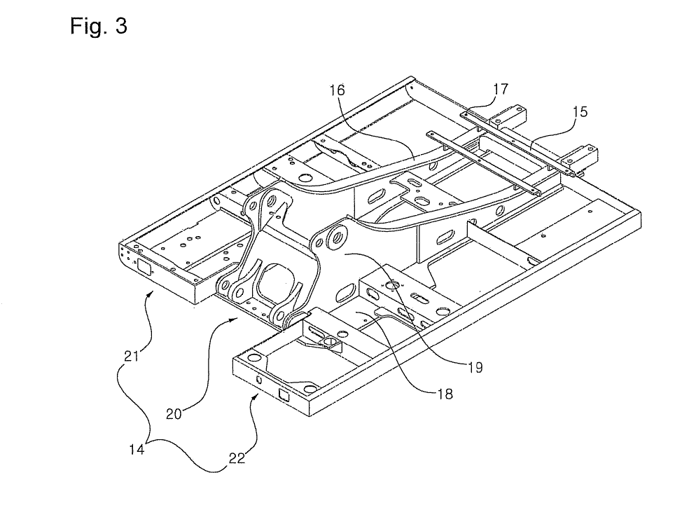

As shown in FIGS. 2 and 3, a hybrid construction machine having an engine 10 and a generator 12 that are mounted on an upper frame 14 in accordance with an embodiment of the present invention includes:

a power component 13 including the generator 12 connected between the engine 10 and a hydraulic pump 11; and

a plurality of fixing plates 15 securely fixed to the upper frame 14, each fixing plate having mounting holes 17 formed thereon to allow the power component 13 to be securely fixed thereto.

Preferably, the fixing plates 15 are securely fixed to the top surface of a top plate 16 of the upper frame 14.

At least three mounting holes 17 are formed on each of the fixing plates 15 so that the power component 13 can be mounted on the fixing plates 15 in at least six-point supporting manner.

Each of the fixing plate 15 is formed to have a length projecting to the outside of the top plate 16, and has a cross section formed in a “ [symbol] ” shape.

In this case, the upper frame 14 includes a center frame 20 which consists of a bottom plate 18 and a pair of opposed side plates 19 formed vertically upwardly from the bottom plate 18 and on which an work apparatus, i.e., an attachment is to be mounted, a right frame 21 which is connected to a right end of the center frame 20 and on which a cooling system or the like is to be mounted, and a left frame 20 which is connected to a left end of the center frame 20 and on which an operator's cab or the like is to be mounted.

Hereinafter, a use example of a hybrid construction machine in accordance with an embodiment of the present invention will be described in detail with reference to the accompanying drawings.

As shown in FIGS. 2 and 3, the plural fixing plates 15 having a cross section formed in a “ [symbol] ” shape are weldingly fixed to the top plate 16 of the upper frame 14. In this case, since the fixing plates 15 have a cross section formed in a “ [symbol] ” shape, the mounting height of the component 13 on the upper frame 14 can be ensured. In addition, since the fixing plates 15 are securely fixed to the top plate 16 with them being flush with each other horizontally, the power component 13 mounted on the fixing plates 15 is maintained in a horizontal state.

The power component 13 has a long axis length since the generator 12 is connected between the engine 10 and the hydraulic pump 11. For this reason, each of the fixing plates 15 is formed to have a length projecting to the outside of the top plate 16 and has at least three mounting holes 17 formed thereon so that the power component 14 having a long axis length has a plurality of mounting points so as to be stably supported.

Thus, the power component 13 having a long axis length is mounted on the upper frame 14 in a six-point-supporting manner by means of fastening members engaged in the mounting holes 17 (e.g., three mounting holes 17 are formed on each fixing plate 15) of the fixing plates 15 securely fixed to the top plate 16. Consequently, the power component 13 having a long axis length can be stably mounted on the upper frame 14.

Meanwhile, a configuration in which the hydraulic pump 11 is driven by using the engine 10 and the generator 12, and an attachment is driven by controlling a hydraulic fluid supplied to a hydraulic actuator from the hydraulic pump 11 is known to those skilled in the art to which the present invention pertains, and thus a detailed description thereof will be omitted to avoid redundancy.

### INDUSTRIAL APPLICABILITY

As described above, according to the hybrid construction machine of the present invention as constructed above, the power component including the generator interposed between the engine and the hydraulic pump has a plurality of mounting points so that the power component can be stably supported. In addition, the power component is simply mounted on the fixing plates securely fixed to the top plate of the upper frame with the fixing plates being flush with each other horizontally, thereby improving workability.

1. A hybrid construction machine having an engine and a generator that are mounted on an upper frame, comprising:
a power component including the generator connected between the engine and a hydraulic pump; and
a plurality of fixing plates securely fixed to the upper frame, each fixing plate having one or more mounting holes formed thereon to allow the power component to be securely fixed thereto.

2. The hybrid construction machine according to claim 1, wherein the fixing plates are securely fixed to a top plate of the upper frame.

3. The hybrid construction machine according to claim 1, wherein each of the fixing plates has at least three mounting holes formed thereon so that the power component can be mounted on the fixing plates in at least six-point supporting manner.

4. The hybrid construction machine according to claim 2, wherein each of the fixing plates is formed to have a length projecting to the outside of the top plate, and has a cross section formed in a “ [symbol] ” shape.
